(19) United States
(12) Patent Application Publication
(10) Pub. No.: US 2020/0045247 A1
(43) Pub. Date: Feb. 6, 2020

(54) IMAGING APPARATUS, CONTROL METHOD, RECORDING MEDIUM, AND INFORMATION PROCESSING APPARATUS

(71) Applicant: CANON KABUSHIKI KAISHA, Tokyo (JP)

(72) Inventors: Satoshi Okamoto, Kawasaki-shi (JP); Tomohiro Harada, Yokohama-shi (JP)

(21) Appl. No.: 16/515,545

(22) Filed: Jul. 18, 2019

(30) Foreign Application Priority Data
Aug. 1, 2018 (JP) 2018-145090

(51) Int. Cl. H04N 5/33; H04N 5/265; H04N 5/225; G06T 5/50

(52) U.S. Cl. CPC H04N 5/332; H04N 5/265; G06T 2207/20221; G06T 5/50; H04N 5/2258

(57) ABSTRACT

To provide a technology for easily determining a change in hue caused due to switching between a visible image and a combined image.

In an imaging apparatus 101 capable of imaging a visible image and an infrared image, a combination unit 110 combines the visible image and the infrared image to generate a combined image. A superimposition unit 114 superimposes combination information indicating a combination ratio of the visible image to the infrared image on the combined image.

### BACKGROUND OF THE INVENTION

### Field of the Invention

The present invention relates to a technology for outputting a combined image based on an image captured with visible light and an image captured with infrared light.

### Description of Related Art

In the related art, to perform imaging with visible light and imaging with infrared light (non-visible light), an imaging apparatus including a visible-light sensor that receives visible light and an infrared sensor that receives infrared light in one optical system is known (Japanese Unexamined Patent Publication No. 2010-103740). In an environment in which illumination is low, or the like, a color image with little noise can be acquired by combining image data output by the visible-light sensor (visible image) and image data output by the infrared sensor (infrared image).

In such a combined image, color is included. Therefore, visibility is higher compared to the infrared image, but color reproduction is different compared to the visible image. Accordingly, as the illumination decreases, the hue of an image may change when the image delivered from a camera is switched from a visible image to the combined image. However, it is difficult for a user to distinguish the visible image from the combined image from image content. Thus, when a change in the hue occurs, it is difficult to ascertain whether the change is caused due to the switching between the visible image and the combined image or is caused due to a change in the surrounding environment of an imaged region.

### SUMMARY OF THE INVENTION

An object of the invention is to provide a technology for easily determining a change in hue caused due to switching between a visible image and a combined image.

An imaging apparatus according to an aspect of the invention is an imaging apparatus capable of imaging a visible image and an infrared image. The imaging apparatus includes: a combination unit configured to combine the visible image and the infrared image to generate a combined image; and a superimposition unit configured to superimpose combination information indicating a combination ratio of the visible image to the infrared image on the combined image.

Further features of the present invention will become apparent from the following description of exemplary embodiments with reference to the attached drawings.

### BRIEF DESCRIPTION OF THE DRAWINGS

FIG. 1 is a block diagram illustrating an imaging system including an imaging apparatus according to a first embodiment.

FIG. 2 is a block diagram illustrating an example of a hardware configuration of the imaging system according to the first embodiment.

FIG. 3 is a flowchart illustrating a process of generating a combined image and superimposing combination information according to the first embodiment.

FIG. 4 is a schematic diagram illustrating an example of the combination information according to the first embodiment.

FIG. 5 is a schematic diagram illustrating another example of the combination information according to the first embodiment.

FIG. 6 is a block diagram illustrating an imaging system including an imaging apparatus according to a second embodiment.

FIG. 7 is a schematic diagram illustrating examples of first superimposition information, second superimposition information, and combination information according to the second embodiment.

FIG. 8 is a schematic diagram illustrating other examples of the first superimposition information, the second superimposition information, and the combination information according to the second embodiment.

FIG. 9 is a block diagram illustrating an imaging system including a client apparatus according to a third embodiment.

### DESCRIPTION OF THE EMBODIMENTS

Hereinafter, modes for carrying out the invention will be described in detail. The embodiments to be described below are examples given to realize the invention and should be appropriately modified or changed in accordance with configurations of apparatuses or various conditions to which the invention is applied. The invention is not limited to the following embodiments.

### First Embodiment

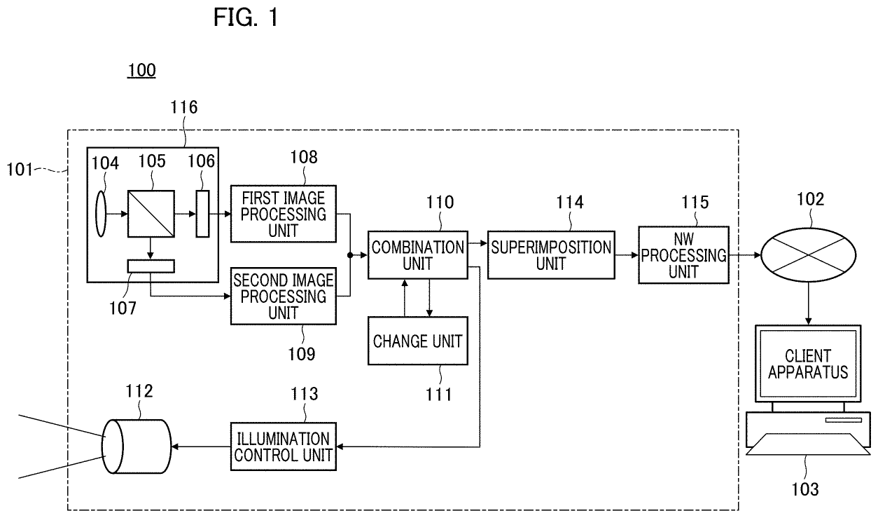

Hereinafter, overviews of a configuration and a function of an imaging apparatus 101 according to a first embodiment will be described with reference to FIG. 1. FIG. 1 is a block diagram illustrating an imaging system 100 including the imaging apparatus 101 according to the first embodiment. The imaging system 100 includes the imaging apparatus 101 and a client apparatus 103.

A network 102 is a network used to connect the imaging apparatus 101 to the client apparatus 103. The network 102 includes, for example, a plurality of routers, switches, and cables that meet a communication standard such as Ethernet (trademark). The communication standard, scale, and configuration of the network 102 do not matter as long as the network 102 can perform communication between the imaging apparatus 101 and the client apparatus 103. The network 102 may be configured with, for example, the Internet, a wired local area network (LAN), a wireless LAN, a wide area network (WAN), or the like.

The client apparatus 103 is, for example, an information processing apparatus such as a personal computer (PC), a server apparatus, or a tablet apparatus. The client apparatus 103 outputs various commands related to control of the imaging apparatus 101 to the imaging apparatus 101. The imaging apparatus 101 outputs images or responses to such commands to the client apparatus 103.

Next, the details of the imaging apparatus 101 will be described. The imaging apparatus 101 is, for example, an imaging apparatus such as a network camera. The imaging apparatus 101 can capture a visible image and an infrared image and is connected to be able to communicate with the client apparatus 103 via the network 102. The imaging apparatus 101 includes an imaging unit 116, a first image processing unit 108, a second image processing unit 109, a combination unit 110, a change unit 111, an infrared illumination unit 112, an illumination control unit 113, a superimposition unit 114, and an NW processing unit 115. The imaging unit 116 can include a lens 104, a wavelength separation prism 105, a first image sensor 106, and a second image sensor 107. The lens 104 is an optical lens that forms an image from light incident from a subject. The wavelength separation prism 105 separates light passing through the lens 104 by wavelength. More specifically, the wavelength separation prism 105 separates the light passing through the lens 104 into a visible-light component with a wavelength of about 400 nm to 700 nm and an infrared component with a wavelength of about 700 nm or more.

The first image sensor 106 converts visible light passing through the wavelength separation prism 105 into an electric signal. The second image sensor 107 converts infrared light passing through the wavelength separation prism 105 into an electric signal. The first image sensor 106 and the second image sensor 107 are, for example, a complementary metal-oxide semiconductor (CMOS), a charged coupled device (CCD), or the like.

The first image processing unit 108 performs a development process on an image signal captured by the first image sensor 106 to generate a visible image. The first image processing unit 108 determines subject illumination of the visible image from a luminance signal of the visible image. The second image processing unit 109 performs a development process on an image signal captured by the second image sensor 107 to generate an infrared image. When resolutions of the first image sensor 106 and the second image sensor 107 are different, any one of the first image processing unit 108 and the second image processing unit 109 performs a resolution conversion process to equalize the resolutions of the visible image and the infrared image. In the embodiment, an imaging apparatus that includes for example, one optical system, two image sensors, and two image processing units will be described. The imaging apparatus 101 may be able to simultaneously capture a visible image and an infrared image of the same subject and to generate the visible image and the infrared image, but the invention is not limited to this configuration. For example, one image sensor that outputs a plurality of image signals corresponding to visible light and infrared light may be used or one image processing unit may process the image signal of the visible image and the image signal of the infrared image.

The combination unit 110 combines the visible image generated by the first image processing unit 108 and the infrared image generated by the second image processing unit 109 based on, for example, Expression (1) below to generate a combined image.

[Math. 1]

Yₛ=αYᵥ+βYᵢ

Cbₛ=αCbᵥ (1)

Crₛ=αCrᵥ

Here, Yₛ, Cbₛ, and Crₛ indicate a luminance signal, a blue color difference signal, and a red color difference signal of the combined image, respectively. Yᵥ, Cbᵥ, and Crᵥ indicate a luminance signal, a blue color difference signal, and a red color difference signal of the infrared image, respectively. Yᵢ is a luminance signal of the infrared image and α and β indicate coefficients.

The change unit 111 decides the coefficients α and β in Expression (1). The change unit 111 decides the coefficients α and β in accordance with, for example, the luminance signal Yᵥ of the image of the visible light and the luminance signal Yᵢ of the infrared image. The change unit 111 changes a combination ratio of the visible image to the infrared image by changing the coefficients α and β. The change unit 111 outputs the decided combination ratio to the combination unit 110.

The infrared illumination unit 112 radiates the infrared light to a subject. The illumination control unit 113 controls switching of ON/OFF of the infrared light or strength and weakness of the infrared light based on the combination ratio or the combined image generated by the combination unit 110. For example, when the coefficient β of the infrared image is 0, the combined image output from the combination unit 110 is an image of only the visible image. Therefore, the illumination control unit 113 may control the infrared illumination unit 112 such that the infrared illumination unit 112 is turned off. The superimposition unit 114 generates combination information indicating the combination ratio of the visible image to the infrared image as an on-screen-display (OSD) image and superimposes the OSD image on the combined image. The combination information is, for example, characters or a figure and is superimposed on the combined image with color or luminance in accordance with the combination ratio. The details of the combination information superimposed on the combined image will be described later. Here, the combination ratio may be a ratio of α to β or may be decided based on the luminance signals of the visible image and the infrared image as in a ratio of αYᵥ to (1−α)Yᵢ. The NW processing unit 115 outputs the combined image, a response to a command from the client apparatus 103, or the like to the client apparatus 103 via the network 102.

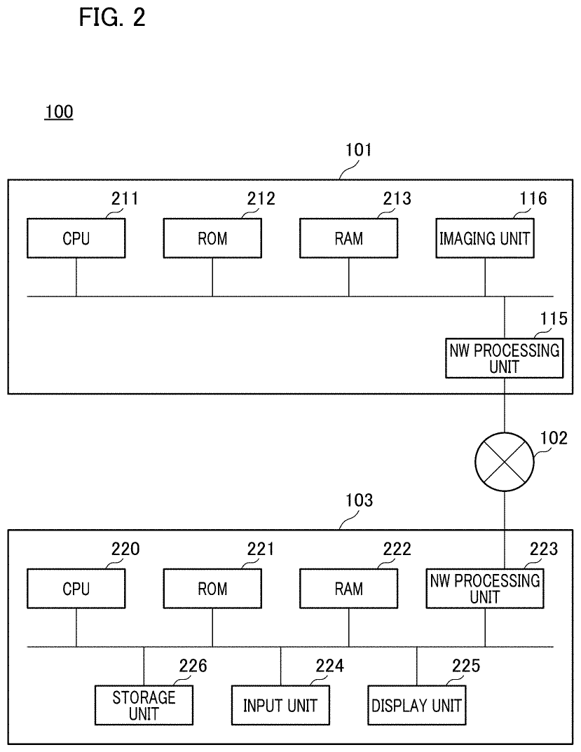

FIG. 2 is a block diagram illustrating an example of a hardware configuration of the imaging system 100 according to the first embodiment. The imaging apparatus 101 includes a CPU 211, a ROM 212, a RAM 213, the imaging unit 116, and the NW processing unit 115. The CPU 211 reads a program stored in the ROM 212 and controls a process of the imaging apparatus 101. The RAM 213 is used as a temporary storage region such as a main memory, a work area, or the like of the CPU 211. The ROM 212 stores a boot program or the like. When the CPU 211 performs a process based on a program stored in the ROM 212, a function of the imaging apparatus 101, a process of the imaging apparatus 101, and the like are realized.

The client apparatus 103 includes a CPU 220, a ROM 221, a RAM 222, an NW processing unit 223, an input unit 224, and a display unit 225. The CPU 220 reads a program stored in the ROM 221 and performs various processes. The ROM 221 stores a boot program or the like. The RAM 222 is used as a temporary storage region such as a main memory, a work area, or the like of the CPU 220. The NW processing unit 223 outputs various commands related to control of the imaging apparatus 101 to the imaging apparatus 101 via the network 102 and receives the combined image output from the imaging apparatus 101.

The input unit 224 is a keyboard or the like and performs input of information to the client apparatus 103. The display unit 225 is a display medium such as a display and displays the combined image generated by the imaging apparatus 101 and the combination information which is the combination ratio of the visible image to the infrared image included in the combined image. The input unit 224 and the display unit 225 are independent devices from the client apparatus 103 or may be included in the client apparatus 103. The storage unit 226 is, for example, a storage medium such as a hard disk or an SD card and stores the combined image on which the combination information output from the imaging apparatus 101 is superimposed.

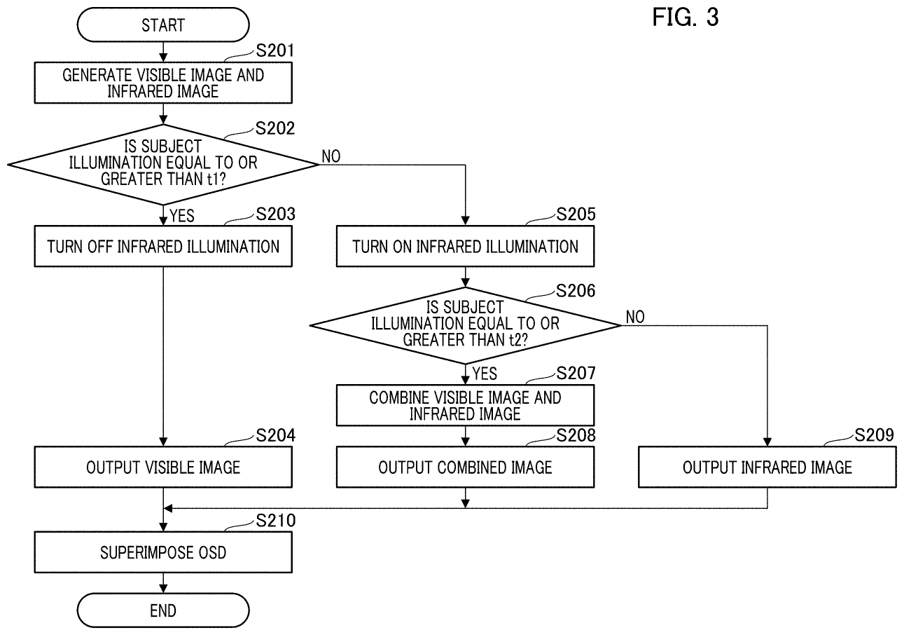

Hereinafter, a flow of generation of the combined image and superimposition of the combination information which is an OSD image will be described with reference to FIG. 3. FIG. 3 is a flowchart illustrating a process of generating a combined image and superimposing combination information according to the first embodiment. First, in S201, electric signals converted by the first image sensor 106 and the second image sensor 107 are processed in the first image processing unit 108 and the second image processing unit 109 to generate the visible image and the infrared image, respectively. Subsequently, in S202, the first image processing unit 108 determines whether subject illumination in the visible image is equal to or greater than t1 and outputs a determination result to the combination unit 110. In the determination of the subject illumination by the first image processing unit 108, for example, the visible image may be divided into a plurality of blocks (for example, 8×8=64), an average value of the luminance signals is calculated for each of the divided blocks, and the subject illumination may be calculated from the average value of the luminance signals for each block. The subject illumination has been calculated from the average value of the luminance signals in the embodiment, but it may be expressed with an integrated value or may be expressed with a value serving as an index of lightness such as an EV value as long as the lightness of each of the divided blocks can be known.

When the subject illumination is equal to or greater than t1 in S202 (YES), the illumination control unit 113 turns off the infrared illumination unit 112 in S203. Subsequently, in S204, the coefficient β of the infrared image is set to 0 in the combination unit 110 and the generated combined image is output to the superimposition unit 114. At this time, since the coefficient β of the infrared image is set to 0, only the visible image is consequently selected in the combination unit 110 and is output to the superimposition unit 114. In the embodiment, however, this image output from the combination unit 110 including such an image is referred to as a combined image.

When the subject illumination in the visible image is less than t1 in S202 (NO), the illumination control unit 113 turns on the infrared illumination unit 112 in S205. Subsequently, in S206, the first image processing unit 108 determines whether the subject illumination in the visible image is equal to or greater than t2 (where t1>t2) and outputs a determination result to the combination unit 110. A method of determining the subject illumination is the same as that in S202. When the subject illumination in the visible image is equal to or greater than t2 in S206 (YES), the combination unit 110 combines the visible image and the infrared image in S207. Subsequently, in S208, the generated combined image is output to the superimposition unit 114. When the subject illumination in the visible image is less than t2 in S206 (NO), the combination unit 110 sets the coefficient α of the visible image to 0 and outputs the generated combined image to the superimposition unit 114 in S209. At this time, since the coefficient α of the visible image is 0, only the infrared image is consequently selected in the combination unit 110 and is output to the superimposition unit 114. Finally, the combination information indicating the combination ratio of the visible image to the infrared image in the combination unit 110 is superimposed on the image input to the superimposition unit 114.

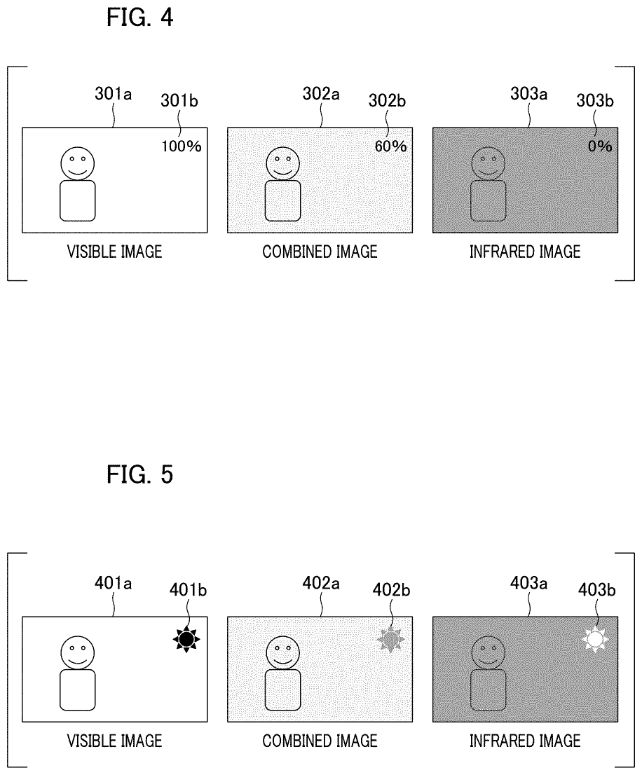

Hereinafter, the details of the combination information will be described. FIG. 4 is a schematic diagram illustrating an example of the combination information according to the first embodiment. In the drawing, an example in which characters are superimposed as combination information is illustrated. A combination ratio is superimposed as a character on a visible image 301a, a combined image 302a, and an infrared image 303a. Characters such as “100%” are superimposed as combination information 301b on the visible image 301a. This indicates that a ratio of the visible image is 100%. Characters such as “60%” are superimposed as combination information 302b on the combined image 302a. This indicates that a ratio of the visible image is 60%. Characters such as “0%” are superimposed as combination information 303b on the infrared image 303a. This indicates that a ratio of the visible image is 0%. In FIG. 4, the combination ratio of the visible image is superimposed, but the combination ratio of the infrared image may be superimposed or a combination ratio of both the visible image and the infrared image may be superimposed.

By superimposing the combination ratio as characters as the combination information, it is possible to easily determine whether the hue of an image is changed due to the combined image or changed for another reason when the hue of the image displayed in the client apparatus 103 is changed. In the case of the combined image, the combination ratio can also be determined. Since the infrared image includes no color, it is easy to determine that an image is the infrared image by checking the image in the client apparatus 103. Accordingly, for the infrared image, the combination ratio may not be superimposed on the image.

FIG. 5 is a schematic diagram illustrating another example of the combination information according to the first embodiment. In the drawing, an example in which a figure of luminance in accordance with a combination ratio is superimposed as combination information is illustrated. A figure of luminance in accordance with each combination ratio is superimposed on the visible image 401a, the combined image 402a, and the infrared image 403a. A figure of black, that is, low luminance, is superimposed as combination information 401b on the visible image 401a. This indicates that a ratio of the visible image is 100%. A figure of white, that is, high luminance, is superimposed as combination information 403b on the infrared image 403a. This indicates that a ratio of the visible image is 0%. A figure of luminance higher than the figure superimposed on the visible image 401a and luminance lower than the figure superimposed on the infrared image 403a, is superimposed as combination information 402b on the combined image 402a. This indicates that the visible image and the infrared image are combined. In the embodiment, the luminance of the combination information is set to be higher as the ratio of the visible image is higher, but the luminance of the combination information may be set to be lower as the ratio of the visible image is higher.

By superimposing the figure of luminance in accordance with the combination ratio in this way, it is possible to easily determine whether the hue of an image is changed due to the combined image or changed for another reason when the hue of the image displayed in the client apparatus 103 is changed. The figure is superimposed with the luminance in accordance with the combination ratio in FIG. 5, but it may be superimposed with a color in accordance with a combination ratio (for example, blue for a visible image 601 and green for the infrared image 603). By repeating the flow of FIG. 3 at a predetermined time interval, there is a possibility of an output image being switched. In the example of FIG. 5, only information corresponding to the combination ratio of the current output image is superimposed, but information regarding both a combination ratio before change and a combination ratio after the change may be superimposed so that a combination ratio before the change transitions to a current combination ratio after the change such as “100%→60% (current).”

### Second Embodiment

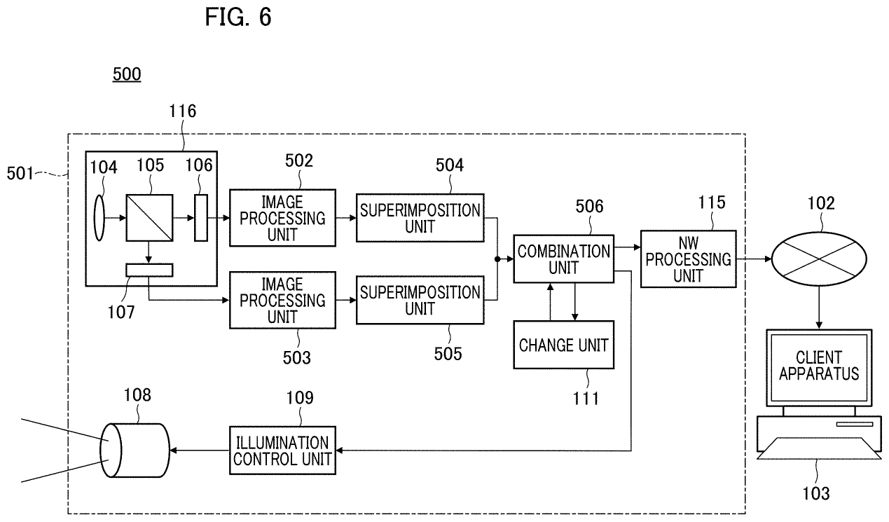

Next, a second embodiment will be described. Details not mentioned in the second embodiment are the same as those of the above-described embodiment. Hereinafter, overviews of a configuration and a function of an imaging apparatus 501 according to the second embodiment will be described with reference to FIG. 6. FIG. 6 is a block diagram illustrating an imaging system 500 including an imaging apparatus 501 according to the second embodiment. Since the network 102, the client apparatus 103, the imaging unit 116, the change unit 111, the infrared illumination unit 112, and the illumination control unit 113 are the same as those of the first embodiment, description thereof will be omitted.

A first image processing unit 502 calculates an average value of luminance signals of a visible image. A second image processing unit 503 calculates an average value of luminance signals of an infrared image. The details of a method of calculating an average value of luminance signals of each image will be described later. A first superimposition unit 504 superimposes first superimposition information such as characters or a figure on the visible image. A second superimposition unit 505 superimposes second superimposition information such as characters or a figure on the infrared image. The details of the first superimposition information and the second superimposition information will be described later. A combination unit 506 combines the visible image on which the first superimposition information is superimposed and the infrared image on which the second superimposition information is superimposed based on Expression (1) of the first embodiment to generate a combined image.

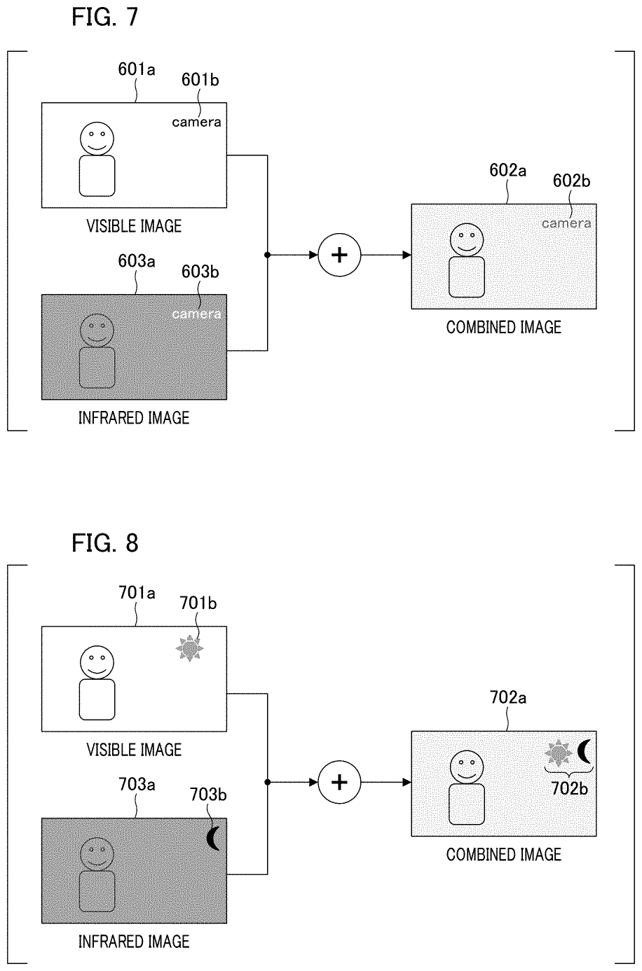

Hereinafter, details of the first superimposition information and the second superimposition information will be described. FIG. 7 is a schematic diagram illustrating examples of the first superimposition information, the second superimposition information, and the combination information according to the second embodiment. In the drawing, an example in which identical characters are superimposed with different luminance as the first superimposition information and the second superimposition information is illustrated. The identical characters are superimposed with different luminance at the same position on each of a visible image 601a and an infrared image 603a. Characters in black, that is, low luminance, are superimposed as first superimposition information 601b on the visible image 601a. Characters in white, that is, high luminance, are superimposed as second superimposition information 603b on the infrared image 603a.

When the combination unit 506 combines the visible image 601a on which the first superimposition information 601b is superimposed and the infrared image 603a on which the second superimposition information 603b is superimposed, a combined image 602a is generated. Characters of luminance in accordance with the combination ratio are superimposed as the combination information 602b on the combined image 602a by combining the first superimposition information 601b and the second superimposition information 603b. When a combination ratio of the infrared image is 0 (where the coefficient β=0), only the first superimposition information 601b is consequently superimposed as combination information on the visible image 601a and is output to the client apparatus 103. When a combination ratio of the visible image is 0 (where the coefficient α=0), only the second superimposition information 603b is consequently superimposed as combination information on the infrared image 603a and is output to the client apparatus 103.

In this way, by superimposing the first superimposition information and the second superimposition information on the visible image and the infrared image, respectively, to generate the combined image, it is possible to output an image on which the combination information is superimposed to the client apparatus 103. Accordingly, when the hue of the image displayed in the client apparatus 103 is changed, it is possible to easily determine whether the hue of the image is changed due to the combined image or changed for another reason. In FIG. 7, the identical characters are superimposed with different luminance as the first superimposition information and the second superimposition information, but identical figure may be superimposed. The identical characters or figure may be superimposed in different colors (for example, blue for the visible image 601a and green for the infrared image 603a).

FIG. 8 is a schematic diagram illustrating other examples of the first superimposition information, the second superimposition information, and the combination information according to the second embodiment. In the drawing, an example in which identical figures are superimposed as the first superimposition information and the second superimposition information at different positions in a combined image is illustrated. The identical figures are superimposed at different positions on a visible image 701a and an infrared image 703a when a combined image is generated. In the drawing, a figure resembling the sun is superimposed as the first superimposition information 701b on the visible image 701a and a figure resembling the moon is superimposed as second superimposition information 703b on the infrared image 703a. Each luminance of the first superimposition information 701b and the second superimposition information 703b is decided in accordance with an average value of luminance signals of each image. For example, the first image processing unit 502 divides the visible image into a plurality of blocks (for example, 8×8=64), calculates an average value of the luminance signals for each of the divided blocks, and calculates an average value of the luminance signals of the visible image from the average value of the luminance signals for each block. The second image processing unit 503 calculates an average value of luminance signals of the infrared image in accordance with a similar method.

The combination unit 506 combines the visible image 701a on which the first superimposition information 701b is superimposed and the infrared image 703a on which the second superimposition information 703b is superimposed, and generates a combined image 702a. The first superimposition information 701b and the second superimposition information 703b are superimposed on the combined image 702a. Two figures, a figure which is the first superimposition information 701b and a figure which is the second superimposition information 703b, are superimposed as the combination information 702b. A combination ratio can be checked from the luminance of each of the two figures included in the combination information 702b.

In this way, by superimposing the first superimposition information and the second superimposition information on the visible image and the infrared image, respectively, to generate the combined image, it is possible to output an image on which the combination information is superimposed to the client apparatus 103. Accordingly, when the hue of the image displayed in the client apparatus 103 is changed, it is possible to easily determine whether the hue of the image is changed due to the combined image or changed for another reason.

### Third Embodiment

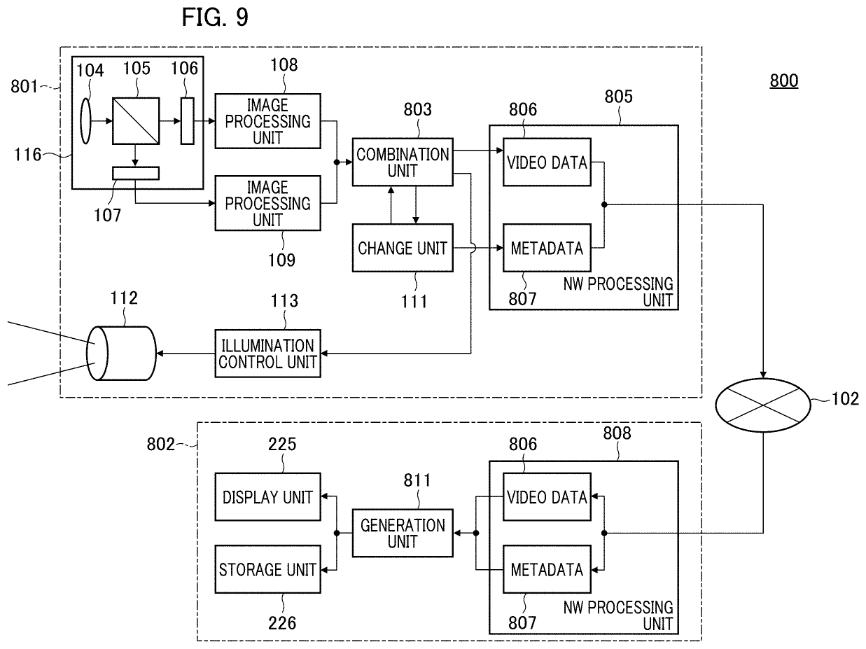

Next, a third embodiment will be described. Details not mentioned in the third embodiment are the same as those of the above-described embodiments. Hereinafter, overviews of a configuration and a function of a client apparatus 802 according to the third embodiment will be described with reference to FIG. 9. FIG. 9 is a block diagram illustrating an imaging system 800 including the client apparatus 802 according to a third embodiment. Since the network 102, the imaging unit 116, the first image processing unit 108, the second image processing unit 109, the change unit 111, the infrared illumination unit 112, and the illumination control unit 113 are the same as those of the first embodiment, the description thereof will be omitted.

A combination unit 803 combines the visible image generated by the first image processing unit 108 and the infrared image generated by the second image processing unit 109 based on Expression (1) according to the first embodiment to generate a combined image. The combination unit 803 outputs the combined image and a combination ratio decided by the change unit 111 to an NW processing unit 805. The NW processing unit 805 outputs the combined image (video data 806) generated by the combination unit 803 and the combination ratio (metadata 807) decided by the change unit 111 to the client apparatus 802 via the network 102.

The client apparatus 802 includes an NW processing unit 808, a generation unit 811, a display unit 812, and a storage unit 813. The NW processing unit 808 receives the video data 806 and the metadata 807 output from the imaging apparatus 801 via the network 102. The generation unit 811 generates combination information indicating a combination ratio of the visible image to the infrared image from the metadata 807 as an OSD image. The generation unit 811 may superimpose the combination information on the video data 806 as in the first embodiment. For example, the combination information may be similar to the combination information of the first embodiment or may be a character string or the like from which the combination ratio can be understood. The display unit 812 is a display medium such as a display and displays the combined image and the combination information. The display unit 812 may superimpose and display the combined image and the combination information or may arrange and display the combined image and the combination information, or the like, without superimposing the combined image and the combination information for display. The storage unit 813 is, for example, a storage medium such as a hard disk or an SD card and stores the combined image and the combination information.

In this way, by displaying the combination ratio received as the metadata along with the combined image, it is possible to easily determine whether hue of an image is changed due to the combined image or changed for another reason when the hue of the image displayed in the client apparatus 103 is changed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-145090, filed Aug. 1, 2018, which is hereby incorporated by reference wherein in its entirety.

What is claimed is:

1. An imaging apparatus capable of imaging a visible image and an infrared image, the imaging apparatus comprising:
a combination unit configured to combine the visible image and the infrared image to generate a combined image; and
a superimposition unit configured to superimpose combination information indicating a combination ratio of the visible image to the infrared image on the combined image.

2. The imaging apparatus according to claim 1, wherein the combination information is text or a figure.

3. The imaging apparatus according to claim 1, wherein the combination information is superimposed with color or luminance in accordance with the combination ratio.

4. The imaging apparatus according to claim 1, wherein the combination ratio is decided based on luminance signals of the visible image and the infrared image.

5. The imaging apparatus according to claim 1, further comprising:
an output unit configured to output the combined image on which the combination information is superimposed to an information processing device.

6. An imaging apparatus capable of imaging a visible image and an infrared image, the imaging apparatus comprising:
a first superimposition unit configured to superimpose first superimposition information on the visible image;
a second superimposition unit configured to superimpose second superimposition information on the infrared image; and
a combination unit configured to combine the visible image on which the first superimposition information is superimposed and the infrared image on which the second superimposition information is superimposed to generate a combined image.

7. The imaging apparatus according to claim 6, wherein the combination unit is configured to generate a combined image on which combination information indicating a combination ratio of the visible image to the infrared image is superimposed.

8. The imaging apparatus according to claim 7, further comprising:
an output unit configured to output the combined image on which the combination information is superimposed to an information processing device.

9. The imaging apparatus according to claim 6, wherein the first superimposition information and the second superimposition information are characters or figures.

10. The imaging apparatus according to claim 6, wherein the first superimposition information and the second superimposition information are identical characters or figures and have different colors or luminance.

11. The imaging apparatus according to claim 6, wherein the first superimposition information and the second superimposition information are different characters or figures and are superimposed to be located at different positions in the combined image.

12. The imaging apparatus according to claim 1, further comprising:
a first imaging unit configured to image the visible image; and
a second imaging unit configured to image the infrared image.

13. The imaging apparatus according to claim 1, further comprising:
a change unit configured to alternate the combination ratio of the visible image to the infrared image.

14. A control method for an imaging apparatus capable of imaging a visible image and an infrared image, the method comprising:
combining the visible image and the infrared image to generate a combined image; and
superimposing combination information indicating a combination ratio of the visible image to the infrared image on the combined image.

15. A non-transitory storage medium on which is stored a computer program for making a computer execute a method for an imaging apparatus capable of imaging a visible image and an infrared image, the method comprising:
combining the visible image and the infrared image to generate a combined image; and
superimposing combination information indicating a combination ratio of the visible image to the infrared image on the combined image.

16. An information processing apparatus capable of communicating with an imaging apparatus that images a visible image and an infrared image and outputs a combined image of the visible image and the infrared image and information regarding a combination ratio of the combined image, the information processing apparatus comprising:
a generation unit configured to generate combination information indicating a combination ratio of the visible image to the infrared image based on information regarding the combination ratio; and
a display unit configured to display the combined image and the combination information.

17. A control method for an information processing apparatus capable of communicating with an imaging apparatus that images a visible image and an infrared image and outputs a combined image of the visible image and the infrared image and information regarding a combination ratio of the combined image, the method comprising:
generating combination information indicating a combination ratio of the visible image to the infrared image based on information regarding the combination ratio; and
displaying the combined image and the combination information.
